(19) United States
(12) Patent Application Publication
(10) Pub. No.: US 2015/0065594 A1
(43) Pub. Date: Mar. 5, 2015

(54) PROCESS FOR PRODUCING WATER-ABSORBING POLYMER PARTICLES

(71) Applicant: BASF SE, Ludwigshafen (DE)

(72) Inventors: Martin Wendker, Worms (DE); Markus Braun, Heidelberg (DE); Roland Krauss, Neustadt (DE); Francisco Javier Lopez Villanueva, Schifferstadt (DE)

(21) Appl. No.: 14/456,711

(22) Filed: Aug. 11, 2014

(30) Foreign Application Priority Data
Sep. 3, 2013 (EP) 13182771.9

(51) Int. Cl. C08F 122/10

(52) U.S. Cl. CPC C08F 122/10
USPC 521/113

(57) ABSTRACT

A process for preparing water-absorbing polymer particles, comprising polymerisation of a foamed aqueous monomer solution or suspension, drying, grinding and classification, whereas the process further comprising adjusting the amount of foaming agent in the aqueous monomer solution by admixing the aqueous monomer solution with a foaming agent of 1% to 15% by weight based on the amount of ethylenically unsaturated monomer and keeping the solution on a pressure of 6 bar to 15 bar and then expanding the solution.

The present invention relates to a process for preparing water-absorbing polymer particles, comprising polymerisation of a foamed aqueous monomer solution or suspension, drying, grinding and classification, whereas the process further comprising adjusting the amount of foaming agent in the aqueous monomer solution by admixing the aqueous monomer solution with a foaming agent of 1% to 15% by weight based on the amount of ethylenically unsaturated monomer and keeping the solution on a pressure of 6 bar to 15 bar and then expanding the solution.

Being products which absorb aqueous solutions, water-absorbing polymers are used to produce diapers, tampons, sanitary napkins, panty liners, wound dressings and other hygiene articles, but also as water-retaining agents in market gardening. The water-absorbing polymers are also referred to as superabsorbents.

The production of water-absorbing polymer particles is described in the monograph “Modern Superabsorbent Polymer Technology”, F. L. Buchholz and A. T. Graham, Wiley-VCH, 1998, pages 71 to 103.

Water-absorbing foams based on crosslinked monomers comprising acid groups are known, for example from EP 0 858 478 B1, WO 97/31971 A1, WO 99/44648 A1 and WO 00/52087 A1. They are produced, for example, by foaming a polymerizable aqueous mixture which comprises at least 50 mol % of neutralized, ethylenically unsaturated monomers comprising acid groups, crosslinker and at least one surfactant, and then polymerizing the foamed mixture. The polymerizable mixture can be foamed by dispersing fine bubbles of a gas which is inert toward free radicals, or by dissolving such a gas under elevated pressure in the polymerizable mixture and decompressing the mixture. The foams are used, for example, in hygiene articles for acquisition, distribution and storage of body fluids.

Water-absorbing polymer particles are typically used in disposal diapers for absorption of urine and are optimized for this use.

WO 2011/061 315 A1 discloses comminuted foams that exhibit high permeability for liquids and a high swelling speed. WO 2006/082 239 A2 relates to a process for producing water-absorbing particles comprising coating the water-absorbing polymeric particles with an elastic film-forming polymer in a fluidised bed reactor in the range from 0° C. to 50° C. and heat-treating the coated particles at a temperature above 50° C.

It was an object of the present invention to provide water-absorbing polymeric foams with an adjustable profile of properties, such as saline flow conductivity (SFC) and/or free swell rate (FSR).

The object was achieved by a process for producing water-absorbing polymer particles by polymerising a foamed aqueous monomer solution or suspension comprising

a) at least one ethylenically unsaturated monomer which bears acid groups and has been neutralised to an extent of 25 to 95 mol %,

b) at least one crosslinker,

c) at least one initiator and

d) optionally at least one surfactant,

e) optionally one or more ethylenically unsaturated monomers copolymerisable with the monomers mentioned under a),

f) optionally a solubiliser and

g) optionally thickeners, foam stabilisers, polymerisation regulators, fillers, fibres and/or cell nucleators,

wherein the monomer solution or suspension containing less than 50 ppm of azo-initiator or being essentially free of azo-initiator being polymerised to a polymeric foam that is dried, subsequently ground and classified,

the process further comprising

adjusting the amount of foaming agent in the aqueous monomer solution or suspension by admixing the aqueous monomer solution or suspension with a foaming agent of 1% to 15% by weight based on the amount of ethylenically unsaturated monomer and keeping the solution on a pressure of 6 bar to 15 bar and then expanding the solution.

Further, a water-absorbing material has been found that is obtainable by the process of this invention. The water-absorbing polymer particles obtained are typically water-insoluble. Further, hygiene articles have been found that comprise the water-absorbing material of the invention.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, an acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The amount of monomer a) is preferably 20 to 90% by weight, more preferably 30 to 85% by weight, most preferably 35 to 75% by weight, based in each case on the unneutralized monomer a) and on the monomer solution or suspension. Based on the unneutralized monomer a) means in the context of this invention that the proportion of the monomer a) before the neutralization is used for the calculation, i.e. the contribution of the neutralization is not taken into account.

The acid groups of the monomers a) have been neutralized to an extent of 25 to 95 mol %, preferably to an extent of 40 to 85 mol %, more preferably to an extent of 50 to 80 mol %, especially preferably to an extent of 55 to 75 mol %, for which the customary neutralizing agents can be used, for example alkali metal hydroxides, alkali metal oxides, alkali metal carbonates or alkali metal hydrogencarbonates, and mixtures thereof. The neutralization can, however, also be undertaken with ammonia, amines or alkanolamines, such as ethanolamine, diethanolamine or triethanolamine.

In a preferred embodiment, at least 50 mol %, preferably at least 75 mol %, more preferably at least 90 mol %, most preferably at least 95 mol %, of the neutralized monomers a) have been neutralized by means of an inorganic base, preferably potassium carbonate, sodium carbonate or sodium hydroxide.

A high degree of neutralization and a high proportion of acid groups neutralized with an inorganic base reduces the flexibility of the polymeric foams obtained and eases the subsequent grinding.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups, more preferred are compounds having at least three polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraalloxyethane, methylenebismethacrylamide, tetraallylammonium chloride, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

Furthermore according to the invention it is preferred that at least two crosslinkers are present in monomer solution or suspension.

The total amount of crosslinker b) is preferably 1 to 10% by weight, more preferably 2 to 7% by weight and most preferably 3 to 5% by weight, based in each case on the unneutralized monomer a). With rising crosslinker content, the centrifuge retention capacity (CRC) falls and the absorption under a pressure of 21.0 g/cm² (AUL 0.3 psi) passes through a maximum.

The initiators c) may be all compounds which generate free radicals under the polymerization conditions, for example thermal initiators, redox initiators, photoinitiators.

Thermal initiators are, for example, peroxides, hydroperoxides, persulfates, especially hydrogen peroxide, tert-butylperoxide, benzoylperoxide, tert-butylperacetate, sodiumpersulfate, potassium persulfate or tert-butylperoxybenzoate.

Photoinitiators are, for example, α-splitters and H-abstracting systems. Suitable α-splitters or H-abstracting systems are, for example, benzophenone derivatives such as Michler's ketone, phenanthrene derivatives, fluorine derivatives, anthraquinone derivatives, thioxanthone derivatives, coumarin derivatives, benzoin ethers, substituted ketones, and derivatives thereof. Preferred are 2-Hydroxy-4′-hydroxyethoxy-2-methylpropiophenon, and 2-Hydroxy-2-methyl-1-phenyl-1-propanone.

The initiators c) are used in customary amounts, preferably at least 0.01 mol %, more preferably at least 0.05 mol %, most preferably at least 1 mol %, and typically less than 5 mol %, preferably less than 2 mol %, based on the monomers a).

In a preferred embodiment surfactants d) are added during the preparation of the foamed monomer solution or suspension to increase its stability. It is possible to use anionic, cationic or nonionic surfactants or surfactant mixtures which are compatible with one another. It is possible to use low molecular weight or else polymeric surfactants, combinations of different types or else the same type of surfactants having been found to be advantageous. Usable nonionic surfactants are, for example, addition products of alkylene oxides, especially ethylene oxide, propylene oxide and/or butylene oxide, onto alcohols, amines, phenols, naphthols or carboxylic acids. The surfactants used are advantageously addition products of ethylene oxide and/or propylene oxide onto alcohols comprising at least 10 carbon atoms, where the addition products comprise 3 to 200 mol of ethylene oxide and/or propylene oxide added on per mole of alcohol. The addition products comprise the alkylene oxide units in the form of blocks or in random distribution. Examples of usable nonionic surfactants are the addition products of 7 mol of ethylene oxide onto 1 mol of tallow fat alcohol, reaction products of 9 mol of ethylene oxide with 1 mol of tallow fat alcohol, and addition products of 80 mol of ethylene oxide onto 1 mol of tallow fat alcohol. Further usable commercial nonionic surfactants consist of reaction products of oxo alcohols or Ziegler alcohols with 5 to 12 mol of ethylene oxide per mole of alcohol, especially with 7 mol of ethylene oxide. Further usable commercial nonionic surfactants are obtained by ethoxylation of castor oil. For example, 12 to 80 mol of ethylene oxide are added on per mole of castor oil. Further usable commercial products are, for example, the reaction products of 18 mol of ethylene oxide with 1 mol of tallow fat alcohol, the addition products of 10 mol of ethylene oxide onto 1 mol of a C₁₃/C₁₅ oxo alcohol, or the reaction products of 7 to 8 mol of ethylene oxide onto 1 mol of a C₁₃/C₁₅ oxo alcohol. Further suitable nonionic surfactants are phenol alkoxylates, for example p-tert-butylphenol which has been reacted with 9 mol of ethylene oxide, or methyl ethers of reaction products of 1 mol of a C₁₂- to C₁₈-alcohol and 7.5 mol of ethylene oxide.

The above-described nonionic surfactants can be converted to the corresponding sulfuric monoesters, for example, by esterification with sulfuric acid. The sulfuric monoesters are used as anionic surfactants in the form of the alkali metal or ammonium salts. Suitable anionic surfactants are, for example, alkali metal or ammonium salts of sulfuric monoesters of addition products of ethylene oxide and/or propylene oxide onto fatty alcohols, alkali metal or ammonium salts of alkylbenzenesulfonic acid or of alkylphenol ether sulfates. Products of the type mentioned are commercially available. For example, the sodium salt of a sulfuric monoester of a C₁₃/C₁₅ oxo alcohol reacted with 106 mol of ethylene oxide, the triethanolamine salt of dodecylbenzenesulfonic acid, the sodium salt of alkylphenol ether sulfates and the sodium salt of the sulfuric monoester of a reaction product of 106 mol of ethylene oxide with 1 mol of tallow fat alcohol are commercial usable anionic surfactants. Further suitable anionic surfactants are sulfuric monoesters of C₁₃/C₁₅ oxo alcohols, paraffinsulfonic acids such as C₁₅ alkylsulfonate, alkyl-substituted benzenesulfonic acids and alkyl-substituted naphthalenesulfonic acids such as dodecylbenzenesulfonic acid and di-n-butylnaphthalenesulfonic acid, and also fatty alcohol phosphates such as C₁₅/C₁₈ fatty alcohol phosphate. The polymerizable aqueous mixture may comprise combinations of a nonionic surfactant and an anionic surfactant, or combinations of nonionic surfactants or combinations of anionic surfactants. Cationic surfactants are also suitable. Examples thereof are the dimethyl sulfate-quaternized reaction products of 6.5 mol of ethylene oxide with 1 mol of oleylamine, distearyldimethylammonium chloride, lauryltrimethylammonium chloride, cetylpyridinium bromide, and dimethyl sulfate-quaternized stearic acid triethanolamine ester, which is preferably used as a cationic surfactant.

The surfactant content, based on the unneutralized monomer a) is preferably 0.01 to 10% by weight, more preferably 0.1 to 5% by weight, most preferably 0.5 to 3% by weight.

Ethylenically unsaturated monomers e) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

Solubilizers f) are water-miscible organic solvents, for example dimethyl sulfoxide, dimethylformamide, N-methylpyrrolidone, monohydric alcohols, glycols, polyethylene glycols or monoethers derived therefrom, where the monoethers comprise no double bonds in the molecule. Suitable ethers are methylglycol, butylglycol, butyldiglycol, methyldiglycol, butyltriglycol, 3-ethoxy-1-propanol and glyceryl monomethyl ether.

If solubilizers f) are used, the content thereof in the monomer solution or suspension is preferably up to 50% by weight, more preferably 1 to 25% by weight, most preferably 5 to 10% by weight.

The monomer solution or suspension may comprise thickeners, foam stabilizers, fillers, fibers and/or cell nucleators g). Thickeners are used, for example, to optimize the foam structure and to improve the foam stability. This achieves the effect that the foam shrinks only slightly during the polymerization. Useful thickeners include all natural and synthetic polymers which are known for this purpose, increase the viscosity of an aqueous system significantly and do not react with the amino groups of the basic polymer. These may be water-swellable or water-soluble synthetic and natural polymers. A detailed overview of thickeners can be found, for example, in the publications by R. Y. Lochhead and W. R. Fron, Cosmetics & Toiletries, 108, 95-135 (May 1993) and M. T. Clarke, “Rheological Additives” in D. Laba (ed.) “Rheological Properties of Cosmetics and Toiletries”, Cosmetic Science and Technology Series, Vol. 13, Marcel Dekker Inc., New York 1993.

Water-swellable or water-soluble synthetic polymers useful as thickeners are, for example, high molecular weight polyethylene glycols or copolymers of ethylene glycol and propylene glycol, and high molecular weight polysaccharides such as starch, guar flour, carob flour, or derivatives of natural substances, such as carboxymethylcellulose, hydroxyethylcellulose, hydroxymethylcellulose, hydroxypropylcellulose and cellulose mixed ethers. A further group of thickeners is that of water-insoluble products such as fine silica, zeolites, bentonite, cellulose powder or other fine powders of crosslinked polymers. The monomer solution or suspension may comprise the thickeners in amounts up to 30% by weight. If such thickeners are used at all, they are present in the monomer solution or suspension in amounts of 0.1 to 10% by weight, preferably 0.5 to 20% by weight.

The water-absorbing polymer particles described herein, may be used as thickeners. Further, conventional water-absorbing polymers (superabsorbents) that are not derived from foams as described herein may be used, in particular superabsorbent fines having a mean particle size below 150 μm.

In order to optimize the foam structure, it is optionally possible to add hydrocarbons having at least 5 carbon atoms in the molecule to the aqueous reaction mixture. Suitable hydrocarbons are, for example, pentane, cyclopentane, hexane, cyclohexane, heptane, octane, isooctane, decane and dodecane. The useful aliphatic hydrocarbons may be straight-chain, branched or cyclic and have a boiling temperature above the temperature of the aqueous mixture during the foaming. The aliphatic hydrocarbons increase the shelf life of the as yet unpolymerized foamed aqueous reaction mixture. This eases the handling of the as yet unpolymerized foams and increases process reliability. The hydrocarbons act, for example, as cell nucleators and simultaneously stabilize the foam already formed. Instead of hydrocarbons or in a mixture therewith, it is optionally also possible to use chlorinated or fluorinated hydrocarbons as a cell nucleator and/or foam stabilizer, such as dichloromethane, trichloromethane, 1,2-dichloroethane, trichlorofluoromethane or 1,1,2-trichlorotrifluoroethane. If hydrocarbons are used, they are used, for example, in amounts of 0.1 to 20% by weight, preferably 0.1 to 10% by weight, based on the monomer solution or suspension.

In order to modify the properties of the foams, it is possible to add one or more fillers, for example chalk, talc, clay, titanium dioxide, magnesium oxide, aluminum oxide, precipitated silicas in hydrophilic or hydrophobic polymorphs, dolomite and/or calcium sulfate. The fillers may be present in the monomer solution or suspension in amounts of up to 30% by weight.

The above-described aqueous monomer solutions or suspensions are first foamed. The foam generation is preferably performed in an inert gas atmosphere and with inert gases under standard pressure or elevated pressure, for example up to 25 bar, and then decompressing. Suitable inert gases as foaming agents are nitrogen or carbon dioxide, whereas carbon dioxide is preferred. The foaming agent preferably is mixed with the aqueous monomer solution or suspension. Whereas it is preferred that the foaming agent is dissolved in the solution.

The amount of foaming agent mixed with the monomer solution or suspension preferably is 1% to 15% by weight based on the total amount of ethylenically unsaturated monomer, more preferably of 2% to 10% by weight, most preferably of 2.5% to 7.5%.

Generally the foaming agent is dissolved under a pressure of 2 to 25bar, whereas it is preferred that the solution is kept on a pressure of 5 to 15 bar, more preferably 7 to 13 bar, most preferably 9 to 11 bar and then to decompress it to standard pressure (pressure drop).

In the course of decompression from at least one nozzle, a free-flowing monomer foam forms. Since gas solubility increases with falling temperature, the gas saturation and the subsequent foaming should be performed at minimum temperature, though undesired precipitations should be avoided.

Therefore the aqueous monomer solution or suspension is preferably foamed at temperatures which are below the boiling point of the constituents thereof, for example at ambient temperature up to 100° C., preferably at −10 to 50° C., more preferably at 0 to 20° C. However, it is also possible to work at temperatures above the boiling point of the component with the lowest boiling point, by foaming the aqueous monomer solution or suspension in a vessel sealed pressure-tight. This gives monomer foams which are free-flowing and stable over a prolonged period.

The performance profile of the polymer particles according to the invention can be adjusted by the pressure drop and the amount of foaming agent dissolved in the monomer solution prior to polymerization, especially carbon dioxide. Both parameters the amount of foaming agent and the pressure drop during decompression have an impact on the free swell rate and the saline flow conductivity of the resulting polymer particles.

Increasing the pressure drop at the nozzle increases the permeability (SFC) and decreases absorption speed (FSR) of the particles.

Increasing the amount of foaming agent added to the monomer solution decreases the permeability (SFC) and increases the absorption speed (FSR).

The density of the monomer foam is, at a temperature of 20° C., 0.01 to 2.5 g/cm³, preferably 0.8 to 2.2 g/cm³, more preferably 1.5 to 2.1 g/cm³.

It is also possible to foam the aqueous monomer solutions or suspensions by another method, by dispersing fine bubbles of an inert gas therein. In the laboratory, the aqueous monomer solutions or suspensions can be foamed, for example, by foaming the aqueous monomer solution or suspension in a food processor equipped with egg beaters. In addition, it is possible to foam the aqueous monomer solutions or suspensions with carbon dioxide, by adding carbonates or hydrogencarbonates.

The consistency of the monomer foams, the size of the gas bubbles and the distribution of the gas bubbles in the monomer foam can further be varied for example, through the selection of the surfactants d), solubilizers f), foam stabilizers, cell nucleators, thickeners and fillers g). This allows the density, the open-cell content and the wall thickness of the monomer foam to be further adjusted.

The resulting monomer foam can be polymerized on a suitable substrate.

The polymerization is performed in the presence of free-radical-forming initiators c). The free radicals can be generated, for example, by heating (thermal initiator/thermal polymerisation) or by irradiation with light of a suitable wavelength (Photoinitiators/photo-polymerisation), whereas UV initiators are preferred.

According to the invention suitable thermal initiators are, for example, peroxides, hydroperoxides, persulfates, especially hydrogen peroxide tert-butylperoxide, benzoylperoxide, tert-butylperacetate, sodiumpersulfate, potassium persulfate or tert-butylperoxybenzoate.

Suitable photoinitiators are, for example, α-splitters, H-abstracting systems and. Suitable α-splitters or H-abstracting systems are, for example, benzophenone derivatives such as Michler's ketone, phenanthrene derivatives, fluorine derivatives, anthraquinone derivatives, thioxanthone derivatives, coumarin derivatives, benzoin ethers, substituted ketones, and derivatives thereof. Preferred are 2-Hydroxy-4′-hydroxyethoxy-2-methylpropiophenon, and 2-Hydroxy-2-methyl-1-phenyl-1-propanone.

According to the present invention it is preferred that during the polymerization process the amount of foaming agent in the solution or suspension does not increase, as this have an impact on the properties of the foam. Therefore initiators, which emit during initiation a gas, such as nitrogen, which is suited as foaming agent are not suitable. Such initiators are for example azo-initiators.

According to the invention the monomer solution or suspension therefore contains less than 50 ppm of azo-initiator, which means that the solution is essentially free of azo-initiator.

Polymeric foams with a layer thickness of up to about 10 millimeters are produced, for example, by heating on one side or both sides, or more particularly by irradiating the monomer foams on one side or both sides. If relatively thick polymeric foams are to be produced, for example polymeric foams with thicknesses of several centimeters, heating of the monomer foam with the aid of microwaves is particularly advantageous, because relatively homogeneous heating can be achieved in this way. With increasing layer thickness, however, the proportion of unconverted monomer a) and crosslinker b) in the resulting polymeric foam increases. The thermal polymerization is effected, for example, at temperatures of 20 to 180° C., preferably in the range from 40° C. to 160° C., especially at temperatures from 65 to 140° C. In the case of relatively thick polymeric foams, the monomer foam can be heated and/or irradiated on both sides, for example with the aid of contact heating or by irradiation or in a drying cabinet. The resulting polymeric foams are open-cell. The proportion of open cells is, for example, at least 80%, preferably above 90%. Particular preference is given to polymeric foams with an open-cell content of 100%. The proportion of open cells in the polymeric foam is determined, for example, with the aid of scanning electron microscopy.

During the polymerization or preferably after the polymerization of the monomer foam, the polymeric foam is dried. In the course of this, water and other volatile constituents are removed. Examples of suitable drying processes are thermal convection drying such as forced air drying, thermal contact drying such as roller drying, radiative drying such as infrared drying, dielectric drying such as microwave drying, and freeze drying.

The drying temperatures are typically in the range of 50 to 250° C., preferably 70 to 200° C., more preferably 90 to 170° C., most preferably 100 to 150° C. The preferred residence time at this temperature in the dryer is preferably 1 to 60 minutes, more preferably 2 to 30 minutes, most preferably at least 5 to 15 minutes.

The drying temperatures are typically in the range of 50 to 250° C., preferably 100 to 220° C., more preferably 120 to 210° C., most preferably 150 to 200° C. The preferred residence time at this temperature in the dryer is preferably at least 10 minutes, more preferably at least 20 minutes, most preferably at least 30 minutes, and typically at most 60 minutes.

In order to avoid undesired decomposition and crosslinking reactions, it may be advantageous to perform the drying under reduced pressure, under a protective gas atmosphere and/or under gentle thermal conditions, under which the product temperature does not exceed 120° C., preferably 100° C. A particularly suitable drying process is (vacuum) belt drying.

According to the invention it is preferred to coat the polymeric foam before drying for reducing the content of unconverted monomers (residual monomers). Suitable coatings are, for example, reducing agents such as the salts of sulfurous acid, of hypophosphorous acid and/or of organic sulfinic acid. However, the reducing agent used is preferably a mixture of the sodium salt of 2-hydroxy-2-sulfinatoacetic acid, the disodium salt of 2-hydroxy-2-sulfonatoacetic acid and sodium hydrogensulfite. Such mixtures are available as Brüggolite® FF6 and Brüggolite® FF7 (Brüggemann Chemicals; Heilbronn; Germany).

After the drying step, the polymeric foam usually comprises less than 15% by weight of water. The water content of the polymeric foam can, however, be adjusted as desired by moistening with water or water vapor.

Thereafter, the dried polymeric foam is ground and classified, and can be ground typically by using one-stage or multistage roll mills, pin mills, hammer mills or vibratory mills. In a preferred embodiment, the dried polymeric foam is first ground by means of a cutting mill and then further ground by means of a turbo mill.

Advantageously, a predried polymeric foam with a water content of 5 to 30% by weight, more preferably of 8 to 25% by weight, most preferably of 10 to 20% by weight, is ground and subsequently dried to the desired final water content. The grinding of a merely predried polymeric foam leads to fewer undesirably small polymer particles.

The water-absorbing polymer particles are screened off using appropriate screens to a particle size in the range from preferably 100 to 1 000 μm, more preferably 150 to 850 μm, most preferably of 150 to 600 μm.

The mean particle size of the polymer particles removed as the product fraction is preferably at least 200 μm, more preferably from 250 to 600 μm and very particularly from 300 to 500 μm. The mean particle size of the product fraction may be determined by means of EDANA recommended test method No. WSP 220.2-05 “Particle size distribution”, where the proportions by mass of the screen fractions are plotted in cumulated form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (undersize) should therefore be small.

Excessively small polymer particles are therefore typically removed and may be recycled into the process. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

The proportion of particles having a particle size of at most 850 μm is preferably at least 90% by weight, more preferably at least 95% by weight, most preferably at least 98% by weight.

The proportion of particles having a particle size of at most 710 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles with too great a particle size are less mechanically stable. The proportion of excessively large polymer particles should therefore likewise be small.

Excessively large polymer particles are therefore typically removed and recycled into the grinding of the dried polymer gel.

The inventive polymer particles are usually not surface postcrosslinked.

But to further improve the properties, the polymer particles can be also surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1, 2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and its derivatives in WO 2003/31482 A1.

Preferred surface postcrosslinkers are ethylene carbonate, ethylene glycol diglycidyl ether, reaction products of polyamides with epichlorohydrin and mixtures of propylene glycol and 1,4-butanediol.

Very particularly preferred surface postcrosslinkers are 2-hydroxyethyloxazolidin-2-one, oxazolidin-2-one and 1,3-propanediol.

In addition, it is also possible to use surface postcrosslinkers which comprise additional polymerizable ethylenically unsaturated groups, as described in DE 37 13 601 A1.

The amount of surface postcrosslinker is preferably 0.001 to 2% by weight, more preferably 0.02 to 1% by weight and most preferably 0.05 to 0.2% by weight, based in each case on the polymer particles.

In a preferred embodiment, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate and lactate. Aluminum sulfate is preferred. Apart from metal salts, it is also possible to use polyamines as polyvalent cations.

The amount of polyvalent cation used is, for example, 0.001 to 1.5% by weight, preferably 0.005 to 1% by weight and more preferably 0.02 to 0.8% by weight, based in each case on the polymer particles.

The surface postcrosslinking is typically performed in such a way that a solution of the surface postcrosslinker is sprayed onto the dried polymer particles. After the spraying, the polymer particles coated with the surface postcrosslinker are dried thermally, and the surface postcrosslinking reaction can take place either before or during the drying.

The spraying of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; US) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

The thermal drying (sometimes referred to as “heat-treating” to distinguish this process step from the step of drying the product of the polymerisation, where typically far more water has to be removed) is preferably carried out in contact driers, more preferably paddle driers, most preferably disk driers. Suitable driers are, for example, Hosokawa Bepex® horizontal paddle driers (Hosokawa Micron GmbH; Leingarten; Germany), Hosokawa Bepex® disk driers (Hosokawa Micron GmbH; Leingarten; Germany) and Nara paddle driers (NARA Machinery Europe; Frechen; Germany). Moreover, it is also possible to use fluidized bed driers.

The drying can be performed in the mixer itself, by heating the jacket or blowing in warm air. Equally suitable is a downstream drier, for example a shelf drier, a rotary tube oven or a heatable screw. It is particularly advantageous to mix and dry in a fluidized bed drier.

As described above for drying the foam, the optimum temperature and the optimum residence time in the dryer obviously depend on the type of dryer used, the foam thickness and whether there is any forced gas stream in the dryer, and a lower temperature can be offset by a longer residence time and vice versa. In the post-crosslinking step, however, it is important to select drying conditions that, besides being suitable to remove water or other solvents, also allow the post-crosslinking reaction to happen. Less reactive post-crosslinkers need higher temperatures and/or longer residence time than more reactive post-crosslinkers. These parameters can easily be optimised by routine experiments. In typical fluidised bed or contact dryers,

The preferred drying temperatures are in the range of 100 to 250° C., preferably 120 to 220° C., more preferably 130 to 210° C. and most preferably 150 to 200° C. The preferred residence time at this temperature in the reaction mixer or drier is preferably 10 to 120 minutes, more preferably 20 to 90 minutes, most preferably 30 to 60 minutes.

Subsequently, the surface postcrosslinked polymer particles can be classified again. excessively small and/or excessively large polymer particles being removed and recycled into the process.

In a preferred embodiment, the surface postcrosslinking is performed as early as the stage of the polymeric foam, in which case the amounts and temperatures specified for the polymer particles apply correspondingly to the polymeric foam.

To improve the properties, the polymer particles can additionally be coated or remoisturized.

The remoisturizing is carried out preferably at 30 to 80° C., more preferably at 35 to 70° C. and most preferably at 40 to 60° C. At excessively low temperatures, the polymer particles tend to form lumps, and, at higher temperatures, water already evaporates noticeably. The amount of water used for remoisturizing is preferably from 1 to 10% by weight, more preferably from 2 to 8% by weight and most preferably from 3 to 5% by weight. The remoisturizing increases the mechanical stability and reduces the tendency to static charging.

Suitable coatings for further improving the free swell rate (FSR) and the saline flow conductivity (SFC) are, for example, inorganic inert substances, such as water-insoluble metal salts, organic polymers, cationic polymers and di- or polyvalent metal cations, such as aluminum sulfate and aluminum lactate. Suitable coatings for dust binding are, for example, polyols. Suitable coatings for counteracting the undesired caking tendency of the polymer particles are, for example, fumed silica, such as Aerosil® 200, and surfactants, such as Span® 20.

Suitable coatings for reducing the content of unconverted monomers (residual monomers) are, for example, reducing agents such as the salts of sulfurous acid, of hypophosphorous acid and/or of organic sulfinic acid. However, the reducing agent used is preferably a mixture of the sodium salt of 2-hydroxy-2-sulfinatoacetic acid, the disodium salt of 2-hydroxy-2-sulfonatoacetic acid and sodium hydrogensulfite. Such mixtures are available as Brüggolite® FF6 and Brüggolite® FF7 (Brüggemann Chemicals; Heilbronn; Germany).

It may also be advantageous to re-moisturise and/or to coat at the stage of the polymeric foam prior to grinding to aid further processing, whereas it is preferred according to the invention to coat the polymeric foam before drying for reducing the content of unconverted monomers (residual monomers)with the suitable coating mentioned above.

The present invention further provides the water-absorbing polymer particles producible from foamed monomer solutions or suspensions by the process according to the invention.

The water-absorbing polymer particles have a moisture content of preferably 0 to 15% by weight, more preferably 0.2 to 10% by weight and most preferably 0.5 to 8% by weight, the water content being determined by EDANA recommended test method No. WSP 230.2-05 “Moisture content”.

The water-absorbing polymer particles produced by the process according to the invention have a centrifuge retention capacity (CRC) of typically at least 10 g/g, preferably at least 15 g/g, more preferably at least 18 g/g, especially preferably at least 22 g/g, very especially preferably at least 25 g/g. The centrifuge retention capacity (CRC) of the water-absorbing polymer particles is typically less than 40 g/g. The centrifuge retention capacity (CRC) is determined by the EDANA recommended test method No. WSP 241.2-05 “Centrifuge retention capacity”.

The water-absorbing polymer particles produced by the process according to the invention have a saline flow conductivity (SFC) of typically at least 10×10⁻⁷ cm³s/g, preferably at least 20×10⁻⁷ cm³s/g, more preferably at least 40×10⁻⁷ cm³s/g, most preferably at least 60×10⁻⁷ cm³s/g. The saline flow conductivity (SFC) of the water-absorbing polymer particles is typically less than 200×10⁻⁷ cm³s/g.

The process according to the invention can produce water-absorbing polymer particles of high saline flow conductivity (SFC) and high free swell rate (FSR); more particularly,

The inventive water-absorbing polymer particles may be mixed with non-inventive polymer gels and/or non-inventive water-absorbing polymer particles. The method of mixing is not subject to any restrictions. The proportion of the inventive water-absorbing polymer particles in the mixture is preferably from 0.1 to 90% by weight, more preferably from 1 to 50% by weight, most preferably from 5 to 25% by weight. The inventive mixtures are notable for surprisingly high saline flow conductivity (SFC).

The water-absorbing polymer particles of the present invention are useful in hygiene articles which comprise inventive water-absorbing polymer particles. The hygiene articles typically comprise a water-impervious backside, a water-pervious topside and, in between, an absorbent core of the inventive polymer particles and cellulose fibers. The proportion of the inventive polymer particles in the absorbent core is preferably 20 to 100% by weight, more preferably 40 to 100% by weight, most preferably 60 to 100% by weight.

### Test Methods

The “WSP” test methods referred to below are described in “Standard Test Methods for the Nonwovens Industry”, 2005 edition, jointly published by “Worldwide Strategic Partners” EDANA (European Disposables and Nonwovens Association, Avenue Eugene Plasky, 157, 1030 Brussels, Belgium, www.edana.org) and INDA (Association of the Nonwoven Fabrics Industry, 1100 Crescent Green, Suite 115, Cary, N.C. 27518, U.S.A., www.inda.org). The publication is available from either EDANA or INDA.

The measurements should, unless stated otherwise, be carried out at an ambient temperature of 23±2° C. and a relative air humidity of 50±10%. The water-absorbing polymer particles are mixed thoroughly before the measurement.

### Centrifuge Retention Capacity (CRC)

Centrifuge Retention Capacity (CRC) is determined using Standard Test Method WSP 241.2 (05).

### Particle Size Distribution (PSD)

Particle Size Distribution is determined using Standard Test Method WSP 220.2 (05).

### Mean Particle Size

The mean particle size of the product fraction is determined using Standard Test Method WSP 220.2 (05), where the proportions by mass of the screen fractions are plotted in cumulated form and the mean particle size is determined graphically. The mean particle size here is the value of the mesh size which gives rise to a cumulative 50% by weight.

### Water or Moisture Content

Water or Moisture Content is determined using Standard Test Method WSP 230.2 (05).

### Saline Flow Conductivity (SFC)

The saline flow conductivity (SFC) of a swollen gel layer under a pressure of 63.3 g/cm² (0.9 psi) is, as described in EP 0 640 330 A1, determined as the gel layer permeability of a swollen gel layer of water-absorbing polymer particles, the apparatus described on page 19 and in FIG. 8 in the aforementioned patent application having been modified to the effect that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The saline flow conductivity (SFC) is calculated as follows:

SFC [cm³s/g]=(Fg(t=0)×L0)/(d×A×WP)

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

### Foam Density

The monomer solution is continuously foamed. For determination of the foam density foam is collected over a period of 15 s in a graduated cylinder of a sufficient size. Within 3 s after collection finished the volume of the foam is measured. Afterwards the weight of the foam volume is determined. Dividing the weight measured in g by the volume determined provides the density of the foam in g/cm³.

### Free Swell Rate (FSR)

To determine the free swell rate (FSR), 1.00 g (=W1) of water-absorbing polymer particles are weighed into a 25 ml beaker and distributed homogeneously over the base thereof. Then 20 ml of a 0.9% by weight sodium chloride solution are metered into a second beaker and the contents of this beaker are added rapidly to the first, and a stopwatch is started. As soon as the last drop of the sodium chloride solution has been absorbed, which is evident by the disappearance of the reflection on the liquid surface, the stopwatch is stopped. The exact amount of liquid which has been poured out of the second beaker and absorbed by the water-absorbing polymer particles in the first beaker is determined accurately by reweighing the second beaker (=W2). The time required for the absorption, which was measured with the stopwatch, is designated as t. The disappearance of the last liquid drop on the surface is determined as the time t.

The free swell rate (FSR) is calculated therefrom as follows:

FSR [g/(g s)]=W2/(W1×t)

When the moisture content of the water-absorbing polymer particles is more than 3% by weight, the weight W1 has to be corrected by this moisture content.

### EXAMPLES

### Example A1

### Synthesis of Water-Absorbing Polymer Particles

In a steel flask of 5 l volume with a bottom outlet, the following amounts of components were continuously mixed:

| | | |
|---|---|---|
| 3.29 | kg/h | acrylic acid, |
| 25.82 | kg/h | aqueous sodium acrylate solution, 37.3% by weight, |
| 0.27 | kg/h | Laromer PO 9044 (ethoxylated glycerine triacrylate, BASF |
| | | SE, 67056 Ludwigshafen, Germany), |
| 0.18 | kg/h | Laromer 9015X (ethoxylated trimethanolepropane |
| | | triacrylate, BASF SE, 67056 Ludwigshafen, Germany), |
| 250.6 | g/h | 4.2 wt.-% solution of Darocur 1173 (2-hydroxy-2- |
| | | methylpropiophenon, BASF SE, 67056 Ludwigshafen, |
| | | Germany) in acrylic acid, the amount of 10.6 g/h Darocur |
| | | 1173 was predissolved in 0.24 g/h acrylic acid separately |
| | | and fed to the reactor, |
| 105.4 | g/h | Lutensol ® AT 80 (ethoxylated alcohol, BASF SE, 67056 |
| | | Ludwigshafen, Germany), |
| 3.6 | kg/h | de-ionised water. |

This mixture was transported via an excenter screw pump into a mixing tube and pressurised by admixing with

| | | |
|---|---|---|
| 260 | g/h | carbon dioxide and |
| 0.44 | kg/h | 15 wt.-% aqueous sodium persulfate solution |

A pressure of 10 bar at an expansion valve placed after the mixing tube was kept constant. The monomer solution spontaneously turned into foam upon discharge from the expansion valve onto a silicone coated belt (SAP-79 McLeod White Silicone Spiral-Link, McLeod Belting) moving at a speed of 1.0 m/min. A coating knife was used to limit the height of the expanding foam to 15 mm.

The foam was irradiated by a total of six 400 W ultraviolet lamps three pairs of lamps in sequence at a height of 17 cm above the foam in a nitrogen-flushed reactor, resulting in a partly polymerised foam structure. The foam was transferred to a metal mesh belt (50% open area, 1.4404 steel, Flat-Flex, Wirebelt) and the foam was irradiated by 30 ultraviolet tubes of 30 W each from above at a height of 4 cm and 25 ultraviolet tubes of 30 W each from below in a depth of 4 cm in a second nitrogen-flushed reactor.

Subsequently, the resulting foam polymer was sprayed with 1.8 kg/h 10 wt.-% aqueous solution of sodium bicarbonate, and finally dried at 150-160° C. in a belt dryer of 8 m length to achieve a moisture content of approx. 10 wt.-%.

The foam thus produced was pre-crushed to approx. 5×5 cm pieces. 100 g each of this material was filled into a kitchen machine (Braun Multiquick 7, 850 W, equipped with rotating blades, Braun GmbH, Frankfurter Str. 145, 61476 Kronberg/Taunus, Germany) and first milled 10 times for 1 s each at full power, then for 12 s also at full power. The product was then sifted with a sifting machine (Retsch AS200, amplitude 1.5 mm/‘g’, Retsch GmbH, Retsch-Allee 1-5, 42781 Haan, Germany) with a lower sieve of 150 μm and an upper sieve of 850 μm for 5 min. The fraction of 150 μm-850 μm was collected.

The resulting polymer was designated Polymer A1.

### Example A2

Same procedure as for Example A1, but the monomer solution was pressurized with 440 g/h carbon dioxide. A polymer with a moisture content of 9.0 wt.-% was obtained.

The resulting polymer was designated Polymer A2.

### Example A3

Same procedure as for Example A1, but the monomer solution was pressurized with 600 g/h carbon dioxide. A polymer with a moisture content of 9.6 wt.-% was obtained.

The resulting polymer was designated Polymer A3.

### Example B1

In a steel flask of 5 l volume with a bottom outlet, the following amounts of components were continuously mixed:

| | | |
|---|---|---|
| 3.65 | kg/h | acrylic acid, |
| 28.08 | kg/h | aqueous sodium acrylate solution, 37.3% by weight, |
| 0.29 | kg/h | Laromer PO 9044 (ethoxylated glycerine triacrylate, |
| | | BASF SE, 67056 Ludwigshafen, Germany), |
| 0.19 | kg/h | Laromer 9015X (ethoxylated trimethanolepropane |
| | | triacrylate, BASF SE, 67056 Ludwigshafen, Germany), |
| 224.6 | g/h | 4.2 wt.-% Darocur 1173 (2-hydroxy-2-methylpropiophenon, |
| | | BASF SE, 67056 Ludwigshafen, Germany) solution in |
| | | acrylic acid, the amount of 9.5 g/h Darocur 1173 was |
| | | predissolved in 0.215 g/h acrylic acid separately and |
| | | fed to the reactor, |
| 115.3 | g/h | Lutensol ® AT 80 (ethoxylated alcohol, BASF SE, 67056 |
| | | Ludwigshafen, Germany), |
| 4.85 | kg/h | de-ionised water. |

This mixture was transported via an excenter screw pump into a mixing tube and pressurised by admixing with

| | | |
|---|---|---|
| 360 | g/h | carbon dioxide and |
| 0.52 | kg/h | 15 wt.-% aqueous sodium persulfate solution |

A pressure of 10 bar at an expansion valve placed after the mixing tube was kept constant. The monomer solution spontaneously turned into foam upon discharge from the expansion valve onto a silicone coated belt (SAP-79 McLeod White Silicone Spiral-Link, McLeod Belting) moving at a speed of 0.72 m/min. A coating knife was used to limit the height of the expanding foam to 10 mm.

The foam was irradiated by a total of six 400 W ultraviolet lamps three pairs of lamps in sequence at a height of 17 cm above the foam in a nitrogen-flushed reactor, resulting in a partly polymerised foam structure. The foam was transferred to a metal mesh belt (50% open area, 1.4404 steel, Flat-Flex, Wirebelt) and the foam was irradiated by 30 ultraviolet tubes of 30 W each from above at a height of 4 cm and 25 ultraviolet tubes of 30 W each from below in a depth of 4 cm in a second nitrogen-flushed reactor.

Subsequently, the resulting foam polymer was dried at 150-160° C. in a belt dryer of 8 m length to achieve a moisture content of approx. 4.3 wt.-%.

The foam thus produced was pre-crushed to approx. 5×5 cm pieces. 100 g each of this material was filled into a kitchen machine (Braun Multiquick 7, 850 W, equipped with rotating blades, Braun GmbH, Frankfurter Str. 145, 61476 Kronberg/Taunus, Germany) and first milled 10 times for 1 s each at full power, then for 12 s also at full power. The product was then sifted with a sifting machine (Retsch AS200, amplitude 1.5 mm/‘g’, Retsch GmbH, Retsch-Allee 1-5, 42781 Haan, Germany) with a lower sieve of 150 μm and an upper sieve of 850 μm for 5 min. The fraction of 150 μm-850 μm was collected.

The resulting polymer was designated Polymer B1.

### Example B2

Same procedure as for Example B1, but the monomer solution was pressurized with 710 g/h carbon dioxide. A polymer with a moisture content of 8.0 wt.-% was obtained.

The resulting polymer was designated Polymer B2.

### Example C1

In a steel flask of 5 l volume with a bottom outlet, the following amounts of components were continuously mixed:

| | | |
|---|---|---|
| 2.21 | kg/h | acrylic acid, |
| 17.01 | kg/h | aqueous sodium acrylate solution, 37.3% by weight, |
| 0.18 | kg/h | Laromer PO 9044 (ethoxylated glycerine triacrylate, |
| | | BASF SE, 67056 Ludwigshafen, Germany), |
| 0.12 | kg/h | Laromer 9015X (ethoxylated trimethanolepropane |
| | | triacrylate, BASF SE, 67056 Ludwigshafen, Germany), |
| 5.8 | g/h | Irgacure 2959 (1-Propanone, 2-hydroxy-1-[4- |
| | | (hydroxyethoxy)phenyl]-2-methyl-, BASF SE, 67056 |
| | | Ludwigshafen, Germany) |
| 135.6 | g/h | 4.2 wt.-% Darocur 1173 (2-hydroxy-2-methylpropiophe- |
| | | non, BASF SE, 67056 Ludwigshafen, Germany) solution in |
| | | acrylic acid, the amount of 5.8 g/h Darocur 1173 was pre- |
| | | dissolved in 0.130 g/h acrylic acid separately and fed to |
| | | the reactor, |
| 69.8 | g/h | Lutensol ® AT 80 (ethoxylated alcohol, BASF SE, 67056 |
| | | Ludwigshafen, Germany), |
| 2.87 | kg/h | de-ionised water. |

This mixture was transported via an excenter screw pump into a mixing tube and pressurised by admixing with

| | | |
|---|---|---|
| 360 | g/h | carbon dioxide and |
| 0.48 | kg/h | 15 wt.-% aqueous sodium persulfate solution |

A pressure of 10 bar at an expansion valve placed after the mixing tube was kept constant. The monomer solution spontaneously turned into foam upon discharge from the expansion valve onto a silicone coated belt (SAP-79 McLeod White Silicone Spiral-Link, McLeod Belting) moving at a speed of 0.72 m/min. A coating knife was used to limit the height of the expanding foam to 10 mm.

The foam was irradiated by a total of six 400 W ultraviolet lamps three pairs of lamps in sequence at a height of 17 cm above the foam in a nitrogen-flushed reactor, resulting in a partly polymerised foam structure. The foam was transferred to a metal mesh belt (50% open area, 1.4404 steel, Flat-Flex, Wirebelt) and the foam was irradiated by 30 ultraviolet tubes of 30 W each from above at a height of 4 cm and 25 ultraviolet tubes of 30 W each from below in a depth of 4 cm in a second nitrogen-flushed reactor.

Subsequently, the resulting foam polymer was dried at 150-160° C. in a belt dryer of 8 m length to achieve a moisture content of approx. 3.6 wt.-%.

The foam thus produced was pre-crushed to approx. 5×5 cm pieces. 100 g each of this material was filled into a kitchen machine (Braun Multiquick 7, 850 W, equipped with rotating blades, Braun GmbH, Frankfurter Str. 145, 61476 Kronberg/Taunus, Germany) and first milled 10 times for 1 s each at full power, then for 12 s also at full power. The product was then sifted with a sifting machine (Retsch AS200, amplitude 1.5 mm/‘g’, Retsch GmbH, Retsch-Allee 1-5, 42781 Haan, Germany) with a lower sieve of 150 μm and an upper sieve of 850 μm for 5 min. The fraction of 150 μm-850 μm was collected.

The resulting polymer was designated Polymer C1.

### Example C2

Same procedure as for Example C1, but the monomer solution was pressurized with 720 g/h carbon dioxide. A polymer with a moisture content of 2.4 wt.-% was obtained.

The resulting polymer was designated Polymer C2.

### Example D1

In a steel flask of 5 l volume with a bottom outlet, the following amounts of components were continuously mixed:

| | | |
|---|---|---|
| 2.03 | kg/h | acrylic acid, |
| 17.01 | kg/h | aqueous sodium acrylate solution, 37.3% by weight, |
| 0.18 | kg/h | Laromer PO 9044 (ethoxylated glycerine triacrylate, |
| | | BASF SE, 67056 Ludwigshafen, Germany), |
| 0.12 | kg/h | Laromer 9015X (ethoxylated trimethanolepropane |
| | | triacrylate, BASF SE, 67056 Ludwigshafen, Germany), |
| 154.8 | g/h | 10% Darocur 1173 (2-hydroxy-2-methylpropiophenon, |
| | | BASF SE, 67056 Ludwigshafen, Germany) solution in |
| | | acrylic acid, the amount of 6.5 g/h Darocur 1173 was |
| | | predissolved in 0.148 g/h acrylic acid separately and |
| | | fed to the reactor, |
| 69.8 | g/h | Lutensol ® AT 80 (ethoxylated alcohol, BASF SE, |
| | | 67056 Ludwigshafen, Germany), |
| 2.87 | kg/h | de-ionised water. |

This mixture was transported via an extender screw pump into a mixing tube and pressurised by admixing with

| | | |
|---|---|---|
| 480 | g/h | carbon dioxide and |
| 0.48 | kg/h | 15 wt.-% aqueous sodium persulfate solution |

A pressure of 8 bar at an expansion valve placed after the mixing tube was kept constant. The monomer solution spontaneously turned into foam upon discharge from the expansion valve onto a silicone coated belt (SAP-79 McLeod White Silicone Spiral-Link, McLeod Belting) moving at a speed of 0.72 m/min. A coating knife was used to limit the height of the expanding foam to 10 mm.

The foam was irradiated by a total of six 400 W ultraviolet lamps three pairs of lamps in sequence at a height of 17 cm above the foam in a nitrogen-flushed reactor, resulting in a partly polymerised foam structure. The foam was transferred to a metal mesh belt (50% open area, 1.4404 steel, Flat-Flex, Wirebelt) and the foam was irradiated by 30 ultraviolet tubes of 30 W each from above at a height of 4 cm and 25 ultraviolet tubes of 30 W each from below in a depth of 4 cm in a second nitrogen-flushed reactor.

Subsequently, the resulting foam polymer was dried at 150-160° C. in a belt dryer of 8 m length to achieve a moisture content of approx. 2.0 wt.-%.

The foam thus produced was pre-crushed to approx. 5×5 cm pieces. 100 g each of this material was filled into a kitchen machine (Braun Multiquick 7, 850 W, equipped with rotating blades, Braun GmbH, Frankfurter Str. 145, 61476 Kronberg/Taunus, Germany) and first milled 10 times for 1 s each at full power, then for 12 s also at full power. The product was then sifted with a sifting machine (Retsch AS200, amplitude 1.5 mm/‘g’, Retsch GmbH, Retsch-Allee 1-5, 42781 Haan, Germany) with a lower sieve of 150 μm and an upper sieve of 850 μm for 5 min. The fraction of 150 μm-850 μm was collected.

The resulting polymer was designated Polymer D1.

### Example D2

Same procedure as for Example D1, but the pressure at the expansion valve was 10 bar. A polymer with a moisture content of 0.6 wt.-% was obtained.

The resulting polymer was designated Polymer D2.

### Example D3

Same procedure as for Example D1, but the pressure at the expansion valve was 14 bar. A polymer with a moisture content of 0.2 wt.-% was obtained.

The resulting polymer was designated Polymer D3.

For all resulting polymers Foam Density, CRC, FSR and SFC are measured. The results are summarized in Tables 1 and 2.

TABLE 1
Impact of amount of CO₂ added to monomer solution
on permeability and absorption speed (FSR).

| | CO₂ [g/h] | | | | |
|---|---|---|---|---|---|
| | added to | Foam | | | SFC |
| Exam- | monomer | density | CRC | FSR | [10⁻⁷ |
| ple | solution | [g/100 cm³] | [g/g] | [g/(g s)] | cm³ s/g] |
| A1 | 260 | 211 | 17.4 | 1.78 | 43 |
| A2 | 440 | 184 | 18.2 | 2.51 | 13 |
| A3 | 600 | 164 | 18.1 | 3.06 | 11 |
| B1 | 360 | 183 | 15.9 | 1.02 | 110 |
| B2 | 710 | 153 | 15.3 | 1.78 | 60 |
| C1 | 360 | 187 | 15.9 | 1.20 | 97 |
| C2 | 720 | 166 | 16.3 | 1.66 | 59 |

TABLE 2
Impact of pressure at the expansion nozzle
on permeability and absorption speed (FSR).

| | CO₂ [g/h] | | | | | |
|---|---|---|---|---|---|---|
| | added to | Pressure | Foam | | | SFC |
| Exam- | monomer | at nozzle | density | CRC | FSR | [10⁻⁷ |
| ple | solution | [bar] | [g/100 cm³] | [g/g] | [g/(g s)] | cm³ s/g] |
| D1 | 480 | 8 | 187 | 17.0 | 2.12 | 39 |
| D2 | 480 | 10 | 172 | 17.5 | 2.08 | 43 |
| D3 | 480 | 14 | 147 | 17.1 | 1.51 | 53 |

1. A process for producing water-absorbing polymer particles comprising polymerising a foamed aqueous monomer solution or suspension comprising
a) at least one ethylenically unsaturated monomer which bears acid groups and has been neutralised to an extent of 25 to 95 mol %,
b) at least one crosslinker,
c) at least one initiator,
d) optionally at least one surfactant,
e) optionally one or more ethylenically unsaturated monomer copolymerisable with the monomer under a),
f) optionally a solubiliser, and
g) optionally thickeners, foam stabilisers, polymerisation regulators, fillers, fibres, and/or cell nucleators,
wherein the monomer solution or suspension contains less than 50 ppm of an azo-initiator or is essentially free of an azo-initiator being polymerised to a polymeric foam that is dried, subsequently ground and classified,
the process further comprising
adjusting an amount of a foaming agent in the aqueous monomer solution or suspension by admixing the aqueous monomer solution or suspension with the foaming agent at 1% to 15% by weight based on the amount of ethylenically unsaturated monomer and keeping the solution under a pressure of 6 bar to 15 bar and then expanding the solution.

2. The process according to claim 1, wherein the foaming agent is carbon dioxide.

3. The process according to claim 1, wherein the monomer solution or suspension comprises at least two initiators c).

4. The process according to claim 3, wherein the at least two initiators are a UV-initiator and a peroxide.

5. The process according to claim 1, wherein at least 50 mol % of the neutralized monomers a) have been neutralized by means of an inorganic base.

6. The process according to claim 5, wherein the inorganic base comprises potassium carbonate, sodium carbonate, or sodium hydroxide.

7. The process according to claim 1, wherein the ground polymeric foam is classified to a particle size in the range from 100 to 1 000 μm.

8. The process according to claim 1, wherein the monomer a) is acrylic acid.

9. The process according to claim 1, wherein the monomer solution or suspension comprises at least two crosslinkers b).

10. Water-absorbing polymer particles prepared by a process of claim 1.

11. Water-absorbing polymer particles according to claim 10, which have a centrifuge retention capacity of at least 10 g/g.

12. Water-absorbing polymer particles according to claim 10, which have a free swell rate of at least 1 g/gs.

13. Water-absorbing polymer particles according to claim 10, which have a saline flow conductivity of at least 10×10⁻⁷ cm³s/g.
